(19) United States
(12) Patent Application Publication
(10) Pub. No.: US 2024/0204717 A1
(43) Pub. Date: Jun. 20, 2024

(54) HYBRID PANEL MANAGEMENT SYSTEM

(71) Applicant: KUKDONG ENERGY Corp, Gyeongsangbuk-do (KR)

(72) Inventor: Myeong Geon SAGONG, Gyeongsangbuk-do (KR)

(73) Assignee: KUKDONG ENERGY Corp, Gyeongsangbuk-do (KR)

(21) Appl. No.: 18/236,389

(22) Filed: Aug. 21, 2023

(30) Foreign Application Priority Data
Dec. 20, 2022 (KR) 10-2022-0179541

(51) Int. Cl. H02S 40/10; H02S 40/42

(52) U.S. Cl. CPC H02S 40/10; H02S 40/425

(57) ABSTRACT

A hybrid panel management system includes a solar photovoltaic panel generating electrical energy by receiving sunlight, a solar thermal panel which is formed on a lower portion of the solar photovoltaic panel and in which a refrigerant flow path where a refrigerant for cooling the solar photovoltaic panel by absorbing heat generated as sunlight irradiates the solar photovoltaic panel flows is formed, a transparent sheet interposed between the solar photovoltaic panel and the solar thermal panel and formed so as to surround upper and lower surfaces of the solar photovoltaic panel, and a cleaning unit rolling the transparent sheet around the solar photovoltaic panel so that the transparent sheet is cleaned by the refrigerant that flows along the refrigerant flow path.

### CROSS REFERENCE TO RELATED APPLICATION

The present application claims priority to Korean Patent 5,000 Application No. 10-2022-0179541, filed Dec. 20, 2022, the entire contents of which are incorporated herein for all purposes by this reference.

### BACKGROUND OF THE INVENTION

### Field of the Invention

The present disclosure relates to a hybrid panel management system capable of preventing a decrease in the amount of power generation due to contamination of a surface of a hybrid panel.

### Description of the Related Art

Currently, as the need for various environmental regulations for preservation of the environment, the risk of existing energy generation facilities such as thermal power generation and nuclear power generation, and problems due to the emission of various pollutions have emerged, new and renewable energy is being greatly highlighted.

Among these new and renewable energies, power generation using sunlight is the most popular, and a hybrid panel is generally used in the power generation facility using sunlight. Furthermore, the power generation facility using sunlight has low construction cost and high construction convenience.

However, since such a hybrid panel generates power through sunlight, the hybrid panel is required to be mounted outside, so that a surface of the hybrid panel may easily become contaminated.

In a large scale solar photovoltaic power generation plant, the surface of the hybrid panel becomes contaminated due to dust, sand, bird excrement, and so on, so that the amount of power generation is reduced. Therefore, when the hybrid panel is contaminated, cleaning is required to be performed.

However, due to characteristics of solar photovoltaic power generation, the hybrid panel is mounted on a high place and is mounted on a large scale, and there is a problem that it is impossible for a person to clean each hybrid panel, so that various hybrid panel cleaning robots are being developed to solve the problem.

### DOCUMENT OF RELATED ART

(Patent Document 1) Korean Patent No. 10-1400397

### SUMMARY OF THE INVENTION

Accordingly, the present disclosure has been made keeping in mind the above problems occurring in the related art, and an objective of the present disclosure is to provide a hybrid panel management system capable of preventing a decrease in the amount of power generation due to contamination of a surface of a hybrid panel.

According to an embodiment of the present disclosure, there is provided a hybrid panel management system including: a solar photovoltaic panel configured to generate electrical energy by receiving sunlight; a solar thermal panel which is formed on a lower portion of the solar photovoltaic panel and in which a refrigerant flow path where a refrigerant for cooling the solar photovoltaic panel by absorbing heat generated as sunlight irradiates the solar photovoltaic panel flows is formed; a transparent sheet interposed between the solar photovoltaic panel and the solar thermal panel and formed such that the transparent sheet surrounds an upper surface and a lower surface of the solar photovoltaic panel; and a cleaning unit configured to roll the transparent sheet with respect to the solar photovoltaic panel so that the transparent sheet is cleaned by the refrigerant that flows along the refrigerant flow path.

In the hybrid panel management system according to an embodiment of the present disclosure, the cleaning unit may include a first roller disposed on a first side of the solar photovoltaic panel and a second roller disposed on a second side of the solar photovoltaic panel, and the transparent sheet may be cleaned by the refrigerant flowing along the refrigerant flow path formed in the solar thermal panel while the transparent sheet is moved between the solar photovoltaic panel and the solar thermal panel when at least one of the first roller and the second roller rolls the transparent sheet.

In the hybrid panel management system according to an embodiment of the present disclosure, the hybrid panel management system may further include: an unmanned aerial vehicle configured to fly over a region in which a plurality of hybrid panels including the solar photovoltaic panel and the solar thermal panel is mounted; and a management server configured to control a flight of the unmanned aerial vehicle and an overall function of the unmanned aerial vehicle and configured to manage the hybrid panels.

In the hybrid panel management system according to an embodiment of the present disclosure, the management server may be configured to receive an image photographed by the unmanned aerial vehicle and may be configured to determine whether the solar photovoltaic panel is contaminated by using artificial intelligence trained from big data about a contamination state of the solar photovoltaic panel.

In the hybrid panel management system according to an embodiment of the present disclosure, the hybrid panel management system may further include a management server configured to manage a plurality of hybrid panels including the solar photovoltaic panel and the solar thermal panel, wherein the solar thermal panel may include a temperature sensor unit configured to measure and collect a difference in refrigerant temperature between an inlet port and an outlet port of the refrigerant flow path, the management server may include a storage unit configured to store a reference range for a contamination determination, and may include a contamination determination unit configured to determine whether the solar photovoltaic panel is contaminated by comparing the difference in refrigerant temperature and the reference range, and the reference range may be a range of an average value of the difference in refrigerant temperature obtained by repeatedly measuring multiple times of the difference in refrigerant temperature of a plurality of the solar photovoltaic panels that is normal, and may be statistical information obtained through repeated experiments.

In the hybrid panel management system according to an embodiment of the present disclosure, the contamination determination unit may determine whether the difference in refrigerant temperature falls within the reference range, may determine that the solar photovoltaic panel is normal when the difference in refrigerant temperature falls within the reference range, and may determine that the solar photovoltaic panel is contaminated when the difference in refrigerant temperature is less than the reference range.

In the hybrid panel management system according to an embodiment of the present disclosure, the solar photovoltaic panel may include a temperature sensor unit configured to measure and collect a difference in refrigerant temperature between an inlet port and an outlet port of the refrigerant flow path, and may include a contamination determination unit configured to determine, on the basis of the difference in refrigerant temperature that is measured, whether the solar photovoltaic panel is contaminated, and the contamination determination unit may determine whether the difference in refrigerant temperature falls within a reference range for a contamination determination, may determine that the solar photovoltaic panel is normal when the difference in refrigerant temperature falls within the reference range, and may determine that the solar photovoltaic panel is contaminated when the difference in refrigerant temperature is less than the reference range.

Other details of implementations according to various aspects of the present disclosure are included in the detailed description below.

According to an embodiment of the present disclosure, a decrease in the amount of power generation due to contamination of a surface of a hybrid panel may be prevented.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating a hybrid panel management system according to a first embodiment of the present disclosure;

FIG. 2 is a block diagram illustrating an unmanned aerial vehicle used in the hybrid panel management system according to embodiments of the present disclosure;

FIG. 3 is a perspective view illustrating a hybrid panel according to the first embodiment of the present disclosure;

FIG. 4 is a view illustrating a state in which the hybrid panel according to the first embodiment of the present disclosure is mounted;

FIG. 5 is a side view of FIG. 4;

FIG. 6 shows views (A), (B) and (C) illustrating an operation state of the hybrid panel management system according to the first embodiment of the present disclosure;

FIG. 7 is a view illustrating the hybrid panel management system according to a second embodiment of the present disclosure;

FIG. 8 is a view illustrating a solar thermal panel for the hybrid panel management system according to the second embodiment of the present disclosure;

FIG. 9 is a view illustrating a management server for the hybrid panel management system according to the second embodiment of the present disclosure;

FIG. 10 is a view illustrating the solar thermal panel for the hybrid panel management system according to a third embodiment of the present disclosure; and

FIG. 11 is a view illustrating a computing device according to an embodiment of the present disclosure.

### DETAILED DESCRIPTION OF THE INVENTION

The present disclosure may be variously modified and may have various embodiments, and specific embodiments will now be described in detail. However, it should be understood that the specific embodiments according to the concept of the present disclosure are not limited to the embodiments which will be described hereinbelow with reference to the accompanying drawings, but all of modifications, equivalents, and substitutions are included in the scope and spirit of the present disclosure.

The terminology used herein is for the purpose of describing specific embodiments only and is not intended to limit the present disclosure. Singular expressions include plural expressions unless the context clearly indicates otherwise. It is to be understood that terms such as ‘including’, ‘having’, and so on are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added. Hereinafter, a hybrid panel management system according to an embodiment of the present disclosure will be described with reference to drawings.

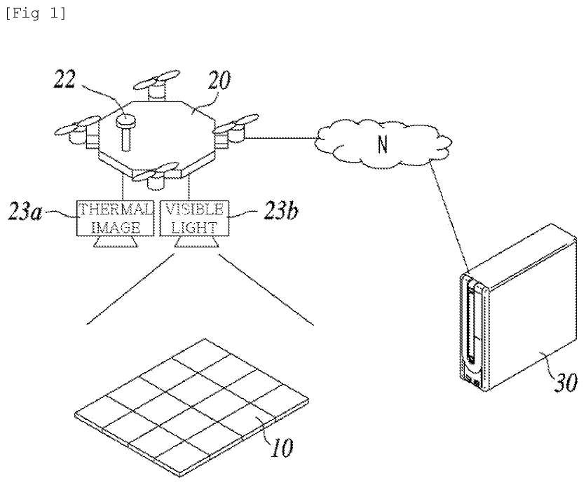

FIG. 1 is a view illustrating a hybrid panel management system according to a first embodiment of the present disclosure.

Referring to FIG. 1, a hybrid panel management system according to a first embodiment of the present disclosure includes an unmanned aerial vehicle 20 configured to fly over a region in which a plurality of hybrid panels 10 is mounted, and includes a management server 30 configured to control a flight of the unmanned aerial vehicle 20 and an overall function of the unmanned aerial vehicle 20 while the management server 30 is communicating with the unmanned aerial vehicle 20 through a communication network N, thereby managing the hybrid panels 10. At this time, as the communication network N, WLAN (Wireless LAN), DLNA (Digital Living Network Alliance), WIBRO (Wireless Broadband), WiMAX (World Interoperability for Microwave Access), HSDPA (High Speed Downlink Packet Access), HSUPA (High Speed Uplink Packet Access), IEEE 802.16, LTE (Long Term Evolution), LTE-A (Long Term Evolution-Advanced), WMBS (Wireless Mobile Broadband Service), and so on exist, and at least one wireless Internet technology which may include not only the above-enumerated techniques but also other non-mentioned Internet techniques may be applied to the communication network N.

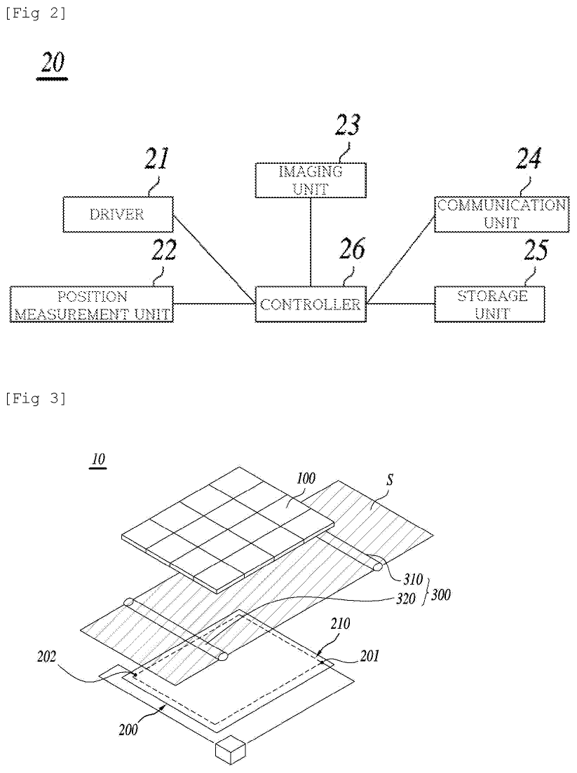

FIG. 2 is a block diagram illustrating an unmanned aerial vehicle used in the hybrid panel management system according to embodiments of the present disclosure.

Referring to FIG. 2, the unmanned aerial vehicle 20 may include a body, a driver 21, a position measurement unit 22, an imaging unit 23, a communication unit 24, a storage unit 25, and a controller 26.

The body is a main frame of the unmanned aerial vehicle 20, and is formed of various materials (for example, including silicon, special alloy materials, and so on) used in the aviation field.

The driver 21 may include a motor, a propeller, and so on related to a flight operation of the unmanned aerial vehicle 20, and may be driven according to a control of the controller 26, thereby being capable of allowing the unmanned aerial vehicle 20 to fly in a desired direction and at a desired altitude.

In addition to a typical GPS module, the position measurement unit 22 may include an RTK GPS (a Real Time Kinematic Global Positioning System) module. The RTK GPS module measures a current position of the unmanned aerial vehicle 20 in real time, and provides highly precise position information with a position error within 5 cm. That is, the RTK GPS module may receive GPS signals transmitted from a satellite, and may measure a position of the unmanned aerial vehicle 20 in real time on the basis of longitude and latitude coordinates included in the received GPS signals. Of course, the position measurement unit 22 is not limited to the RTK GPS module.

The imaging unit 23 may be mounted on a portion outside of the body, includes a thermal imaging camera 23a configured to generate a thermal image, and includes a visible light camera 23b configured to generate a visible light image including an RGB image.

In order to ensure that a surface of the hybrid panel that is disposed slantly at an angle with respect to the ground is accurately photographed, the thermal imaging camera 23a is mounted on the unmanned aerial vehicle 20 with a predetermined photographing angle that is different from a photographing angle of the visible light camera 23b such that the thermal imaging camera 23a is facing the surface of the hybrid panel. In addition, the visible light camera 23b is mounted on the unmanned aerial vehicle 20 such that the visible light camera 23b has a photographing angle perpendicular to the ground.

The imaging unit 23 performs an imaging function for a specific area by a control of the controller 26, and provides a visible light image or a thermal image generated by the imaging function.

The communication unit 24 may transmit the thermal image, the visible light image, and the location information collected through the imaging unit 23 by the control of the controller 26 to the management server 30, and may provide various information received from the management server 30 to the controller 26. For example, the communication unit 24 may receive path related information, control information, and so on related to a flight path related to a flight target region transmitted from the management server 30 by the control of the controller 26.

The storage unit 25 is configured to store data, programs, and so on required for operating the unmanned aerial vehicle 20. The storage unit 25 stores various application programs (or applications) driven in the unmanned aerial vehicle 20, and stores data and commands for operating the unmanned aerial vehicle 20. In addition, the storage unit 25 stores path related information related to a flight path related to an arbitrary flight target region transmitted through the communication unit 24.

The controller 26 is configured to control the overall operation of the unmanned aerial vehicle 20. In addition, the controller 26 is configured to perform the overall control function of the unmanned aerial vehicle 20 by using the programs and the data stored in the storage unit 25. The control 26 may include a RAM, a ROM, a CPU, a GPU, and a bus, and the RAM, the ROM, the CPU, the GPU, and so on may be connected to each other through a bus. The CPU may access the storage unit 25 and may perform booting, and may perform various operations by using various programs, contents, data, and so on stored in the storage unit 25.

In addition, the controller 26 is configured to photograph and collect a thermal image and a visible light image of the flight target region by controlling the imaging unit 23. In addition, the controller 26 is configured to acquire position information of the unmanned aerial vehicle 20 corresponding to an imaging point (or region) of the imaging unit 23 through the RTK GPS module.

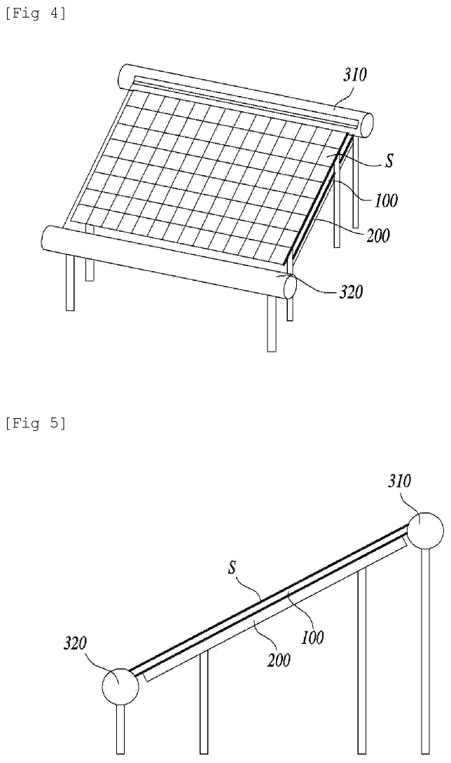

FIG. 3 is a perspective view illustrating a hybrid panel according to the first embodiment of the present disclosure, FIG. 4 is a view illustrating a state in which the hybrid panel according to the first embodiment of the present disclosure is mounted, and FIG. 5 is a side view of FIG. 4.

Referring to FIG. 3 to FIG. 5, the hybrid panel according to the first embodiment of the present disclosure includes a solar photovoltaic panel 100, a solar thermal panel 200, a transparent sheet S, and a cleaning unit 300. As illustrated in FIG. 4 and FIG. 5, the hybrid panel including the solar photovoltaic panel 100 and the solar thermal panel 200 may be mounted slantly so as to maximize a quantity of solar radiation from sunlight.

The solar photovoltaic panel 100 is a device configured to receive sunlight and to convert solar photovoltaic energy into electrical energy. Generally, the solar photovoltaic panel 100 is formed in a rectangular plate shape, has a plurality of solar photovoltaic cells disposed therein, and may be mounted slantly by a separate frame so as to efficiently receive sunlight.

The solar photovoltaic panel 100 may be configured as an aggregate of the solar photovoltaic cells that are a plurality of unit cells. In addition, the solar photovoltaic cell generally generates a voltage of 0.5 V to 0.6 V, i.e., an electric power of approximately 3 W to 4 W. In addition, the solar photovoltaic panel 100 including the plurality of unit solar photovoltaic cells generally has an output of approximately 16 V to 26 V, and approximately 120 W to 300 W.

The solar photovoltaic panel 100 may include a silicon solar cell panel, a dye-sensitized solar cell panel, a compound semiconductor solar cell panel, and a solar cell in a tandem-type solar photovoltaic panel. In addition, the solar photovoltaic panel 100 may include a tab line electrically connecting the plurality of solar cells to each other, glass positioned at an upper portion of the solar cell and configured to protect a component that is positioned inside the glass, a rear surface sheet positioned at a lower portion of the solar cell and configured to support a component that is positioned inside the rear surface sheet, and a bonding material supporting the solar cells, the glass, and the rear surface sheet, but there is no limitation. A detailed configuration of the solar photovoltaic panel 100 is a general configuration, so a detailed description thereof is omitted.

The solar thermal panel 200 is formed in a plate shape, is attached to a lower surface of the solar photovoltaic panel 100, and includes a refrigerant flow path 210 in which a refrigerant for cooling the solar photovoltaic panel 100 flows, the refrigerant absorbing heat generated as sunlight irradiates the solar photovoltaic panel 100.

The refrigerant flow path 210 is mounted in the solar thermal panel 200, may include an inlet port 201 into which the refrigerant is introduced, and may include an outlet port 202 to which the refrigerant is discharged. The temperature of the refrigerant introduced through the inlet port 201 may be increased while flowing along the refrigerant flow path 210, and the refrigerant in which the temperature thereof is increased may be discharged through the outlet port 202.

The solar thermal panel 200 is in contact with a lower portion of the solar photovoltaic panel 100, and absorbs thermal energy generated as the solar photovoltaic panel 100 is heated, thereby being capable of heating the refrigerant flowing in the refrigerant flow path 210 formed within the solar thermal panel 200.

At this time, the refrigerant is a Freon gas-based refrigerant, and may be R-134A or R-407C, but is not limited thereto. Such a Freon gas-based refrigerant does not freeze at 40 degrees Celsius below zero and does not boil equal to or more than 100 degrees Celsius, so that frost is generated around a Freon gas-based refrigerant flow path even in summer. Therefore, the Freon gas-based refrigerant has an effect of effectively cooling the solar photovoltaic panel 100 even in the summer season. In addition, it is preferable that the solar thermal panel 200 is manufactured from a material that has a high thermal transfer efficiency in order to efficiently transfer heat.

The transparent sheet S is interposed between the solar photovoltaic panel 100 and the solar thermal panel 200, and is formed such that the transparent sheet S surrounds an upper surface and a lower surface of the solar photovoltaic panel 100. It is preferable that the transparent sheet S is formed of a flexible material that is not damaged while being rolled by the cleaning unit 300. For example, the transparent sheet S may be a colorless transparent film formed of a high heat resistant polyimide (PI) material that is commonly used for display purposes.

The cleaning unit 300 (including 310 and 320) includes a first roller 310 disposed on a first side of the solar photovoltaic panel 100, and includes a second roller 320 disposed on a second side of the solar photovoltaic panel 100.

The transparent sheet S is formed so as to surround the upper and lower surfaces of the solar photovoltaic panel 100, and is rolled by the first roller 310 and the second roller 320, so that the transparent sheet S may be moved along the upper and lower surfaces of the solar photovoltaic panel 100. When the transparent sheet S is rolled by the cleaning part 300, the transparent sheet S is moved between the solar photovoltaic panel 100 and the solar thermal panel 200. At this time, the refrigerant flowing through the refrigerant flow path 210 formed in the solar thermal panel 200 is in contact with and flows on a surface of the transparent sheet S, so that foreign substances on the surface of the transparent sheet S may be automatically removed. That is, the cleaning unit 300 is configured to roll the transparent sheet S around the solar photovoltaic panel 100, so that the transparent sheet S may be automatically cleaned by the refrigerant flowing through the refrigerant flow path 210.

The management server 30 is configured to receive the image photographed from the unmanned aerial vehicle 20, and is configured to analyze the image and to determine whether the solar photovoltaic panel 100 is contaminated. Specifically, the management server 30 is configured to check whether the transparent sheet S on the solar photovoltaic panel 100 is contaminated. To this end, the management server 30 may analyze the image by using artificial intelligence. The management server 30 may analyze the image photographed by the unmanned aerial vehicle 20 by using artificial intelligence trained from big data about a contamination state of a panel.

The management server 30 is configured to monitor the amount of power generation of the solar photovoltaic panel 100. When the amount of power generation decreases below a reference value due to foreign substances present on the solar photovoltaic panel 100, the management server 30 orders the unmanned aerial vehicle 20 to fly, and the management server 30 instructs the unmanned aerial vehicle 20 to photograph and provide an image of the corresponding solar photovoltaic panel 100.

The unmanned aerial vehicle 20 receives a photographing command along with the location information of the corresponding solar photovoltaic panel 100 from the management server 30, and starts the flight. The unmanned aerial vehicle 20 photographs an image of the solar photovoltaic panel 100 and provides the image to the management server 30.

The management server 30 analyzes the photographed image and checks whether the solar photovoltaic panel 100 is contaminated. When the contamination is confirmed through the image analysis result, the management server 30 transmits a control command to the cleaning unit 300, and orders the transparent sheet S to be rolled.

In addition, the management server 30 may check a crack of the solar photovoltaic panel and heating due to disconnecting by performing the analysis of the image photographed by the unmanned aerial vehicle 20, and may notify the manager of the crack or the heating. To this end, the management server 30 may use artificial intelligence machine-learned on the basis of big data of a defect situation of a solar photovoltaic panel, such as micro-cracking, ignition traces, and so on.

Meanwhile, the management server 30 may estimate whether the solar photovoltaic panel 100 is contaminated without the assistance of the unmanned aerial vehicle 20 by measuring environment information around which the solar photovoltaic panel 100 is mounted, such as temperature, humidity, wind speed, and so on. That is, when the amount of power generation of a large number of solar photovoltaic panels 100 is decreased in an environment such as a sandy wind environment or a dusty environment, the management server 30 may transmit a control command to the cleaning unit 300 that is responsible for the solar photovoltaic panel 100 so that a contaminated state is resolved.

The cells of the solar photovoltaic panel 100 is configured to receive sunlight through the transparent sheet S positioned between the first roller 310 and the second roller 320. A transparent sheet region between the first roller 310 and the second roller 320 is positioned on an upper portion of the surface of the solar photovoltaic panel 100, and protects the surface of the solar photovoltaic panel 100 from the outside environment. Therefore, sand, dust, bird excrement, and so on contaminate the transparent sheet S rather than the surface of the solar photovoltaic panel 100.

Meanwhile, the cells of the solar photovoltaic panel 100 generate electricity by receiving sunlight incident through an effective region of the transparent sheet S. When a contamination of the effective region of the transparent sheet S is confirmed, at least one of the first roller 310 and the second roller 320 is driven so that the transparent sheet S is moved by a predetermined length, and the effective area of the transparent sheet S where the cells receive sunlight is replaced with another region of the transparent sheet S. As a result, the effective area of the transparent sheet S is replaced with a clean region, so that a decrease in the amount of power generation due to contamination may be prevented.

Specifically, a transparent sheet S roll that is wound may be mounted in the first roller. A first end of the transparent sheet S roll is connected to the second roller 320. At least one of the first roller 310 and the second roller 320 may be provided with a driving motor (not illustrated).

When the driving motor is rotated, a first end of the transparent sheet S is pulled, and the effective region of the contaminated transparent sheet S is moved from the first roller 310 to the second roller 320. When the motor is rotated continuously, the transparent sheet S is unwound from the first roller 310 and is wound in the second roller 320, and the effective area of the contaminated transparent sheet S is wound in the second roller 320.

That is, the first roller 310 unwinds the transparent sheet S, and the second roller 320 winds the transparent sheet S. As the cleaning unit 300 is operated, the transparent sheet S roll coupled to the first roller 310 is transferred to the second roller 320.

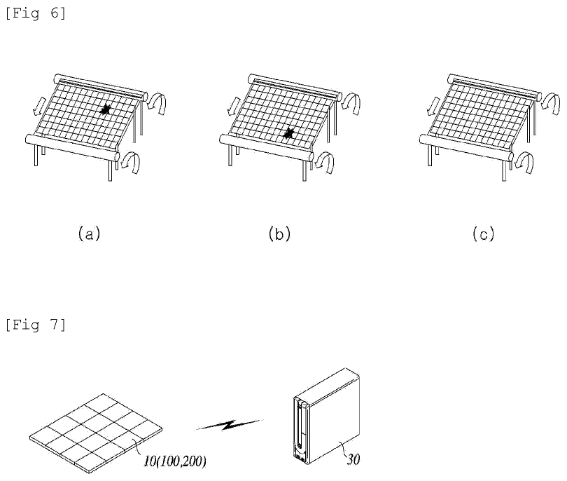

When the cleaning unit 300 receives the control command from the management server 30, the cleaning unit 300 drives the second roller 320 and moves the transparent sheet S so that the effective region of the transparent sheet S is replaced with a new region. (See FIGS. 6A to 6C)

Referring to FIG. 7 to FIG. 9, the hybrid panel management system according to a second embodiment of the present disclosure includes the solar photovoltaic panel 100, the solar thermal panel 200, and the management server 30. Since the solar photovoltaic panel 100 of the second embodiment is substantially the same as the solar photovoltaic panel 100 of the first embodiment, so the repeated description is omitted.

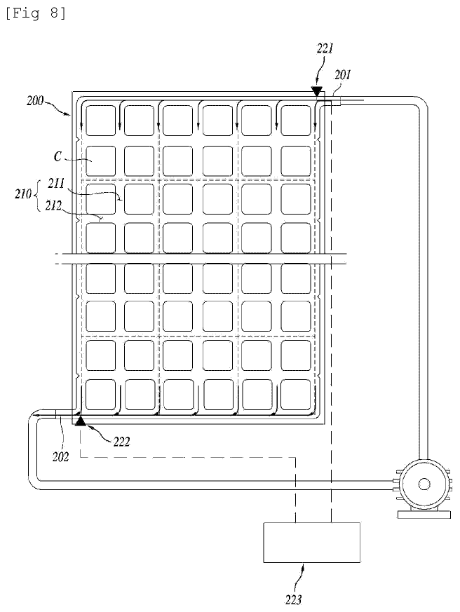

Referring to FIG. 8, the solar thermal panel 200 includes the refrigerant flow path 210 and a temperature sensor unit 220.

The refrigerant flow path 210 may be formed by connecting a plurality of metal pipes to each other such that a plurality of longitudinal flow paths 211 and a plurality of transverse flow paths 212 are formed and a lattice shape is formed. The metal pipes constituting the longitudinal flow path 211 and the transverse flow path 212 are provided with a material having excellent thermal conductivity. Reference numeral C indicates the insulating material that is disposed on a region formed by the longitudinal flow path 211 and the transverse flow path 212.

The temperature sensor unit 220 is configured to measure and collect a difference in refrigerant temperature between the inlet port 201 and the outlet port 202 of the refrigerant flow path 210. Specifically, the temperature sensor unit 220 includes a first temperature sensor 221, a second temperature sensor 222, and a communicating unit 223. The first temperature sensor 221 is mounted in the inlet port 201 and measures a first temperature value of the refrigerant introduced, the second temperature sensor 222 is mounted in the outlet port 202 and measure a second temperature value of the refrigerant that is discharged through the outlet port 202 after the refrigerant absorbs heat while flowing along the refrigerant flow path 210. The communicating unit 223 is configured to transmit the first and second temperature values measured by the first temperature sensor 221 and the second temperature sensor 222 to the management server 30.

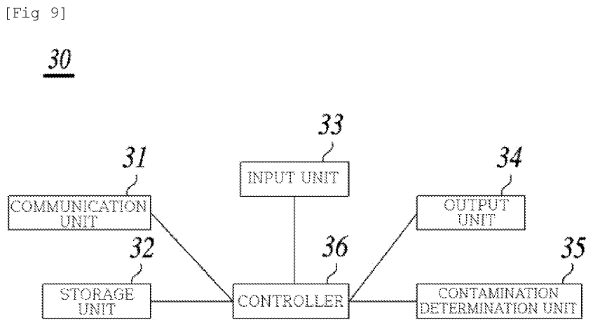

Referring to FIG. 9, the management server 30 includes a communication unit 31, a storage unit 32, an input unit 33, an output unit 34, a contamination determination unit 35, and a controller 36.

The communication unit 31 communicates with the communicating unit 323 through a communication network, and receives the first temperature value, the second temperature value, and so on transmitted from the communicating unit 323.

The storage unit 32 is configured to store data, programs, and so on required for operating the management server 30. In addition, the storage unit 32 may store reference information for determining contamination. The reference information may be a range (reference range) of a refrigerant temperature difference in a normal solar photovoltaic panel. The reference information may be statistical information obtained through repeated experiments. For example, the reference information may be an average value of the refrigerant temperature difference (the second temperature value−the first temperature value) obtained by repeatedly measuring the first temperature value of the first temperature sensor 221 and the second temperature value of the second temperature sensor 222 on the plurality of normal solar photovoltaic panels that have no contamination. This average value may vary according to external environmental factors such as a sun altitude/weather and so on, and may be an average value of a predetermined range obtained through the same/similar process in each external environment.

The input unit 33 may be configured to receive a signal according to a button operation by a user input or a selection of an arbitrary function, or may be configured to receive a command or a control signal generated by a user input such as touching/scrolling a displayed screen. Furthermore, the input unit 33 may provide an input signal related to a user input to the controller 36.

The output unit 34 displays various contents such as various menu screens by using a user interface and/or a graphical user interface.

When a contamination of the solar photovoltaic panel 100 occurs by foreign substances, solar heat that the solar photovoltaic panel 100 receives is reduced, so that the temperature increase width of the refrigerant flowing through the refrigerant flow path 210 of the solar thermal panel 200 in contact with and mounted at the lower surface of the solar photovoltaic panel 100 is abnormally reduced. The contamination determination unit 35 uses this principle and determines, on the basis of the refrigerant temperature difference, whether the solar photovoltaic panel 100 is contaminated.

That is, the contamination determination unit 35 calculates the refrigerant temperature difference (the second temperature value−the first temperature value) from the difference between the first temperature value and the second temperature value received from the communication unit 31, and compares the calculated refrigerant temperature difference with the reference information to determine whether the solar photovoltaic panel 100 is contaminated.

Specifically, the contamination determination unit 35 reads the reference information for determining contamination, the reference information being stored in the storage unit 32. The reference information may be a range (reference range) of an average value of a refrigerant temperature difference (the second temperature value−the first temperature value) obtained by repeatedly measuring the first and second temperature values of a plurality of normal solar photovoltaic panels. The contamination determination unit 35 determines whether the calculated refrigerant temperature difference falls within the reference range, determines that the panel is normal when the calculated refrigerant temperature difference falls within the reference range, and determines that the panel is contaminated when the calculated refrigerant temperature difference is less than the reference range. In principle, the determination of the contamination determination unit 35 is performed on the basis of a contamination of the solar photovoltaic panel 100, but the same result (a decrease in a temperature increase width of the refrigerant) is also caused by a contamination of the transparent sheet S that surrounds the solar photovoltaic panel 100, so that whether the transparent sheet S is contaminated may be determined on the basis of the refrigerant temperature difference.

When the contamination panel is determined by the contamination determination unit 35, the controller 36 generates a control command that drives at least one of the first roller 310 and the second roller 320 that constitute the cleaning unit 300 of the hybrid panel, and transmits the control command to a control circuit of the driving motor that drives the first roller 310 and the second roller 320. When the driving motor is rotated, the transparent seat S is rolled, and at the same time, the contaminated region of the transparent sheet S may be automatically cleaned by the refrigerant that flows through the refrigerant flow path 210 while the transparent sheet S is moved between the solar photovoltaic panel 100 and the solar thermal panel 200.

Unlike the first embodiment described above, according to the second embodiment, there is an advantage that the contamination of the solar photovoltaic panel is capable of being determined without using the unmanned aerial vehicle 20 and the solar photovoltaic panel is capable of cleaned since the contamination of the solar photovoltaic panel (specifically, the transparent sheet) is determined by using the temperature difference of the refrigerant that flows along the refrigerant flow path 210 of the solar thermal panel 200.

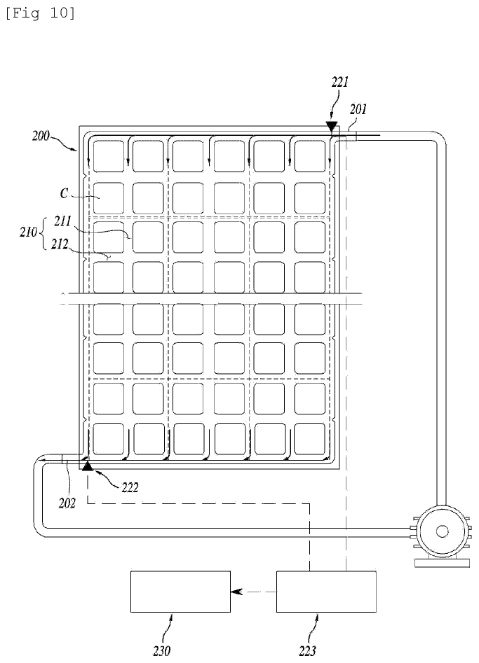

Next, referring to FIG. 10, the hybrid panel management system according to a third embodiment of the present disclosure is described. FIG. 10 is a view illustrating the solar thermal panel for the hybrid panel management system according to a third embodiment of the present disclosure.

Referring to FIG. 10, the solar thermal panel 200 for the hybrid panel management system according to a third embodiment of the present disclosure includes the refrigerant flow path 210, the temperature sensor unit 220, and a contamination determination unit 230.

In the second embodiment described above, although the contamination determination unit 35 has been described as being implemented on the management server 30, the contamination determination unit 35 does not necessarily have to be a single configuration of the management server 30. Furthermore, as illustrated in FIG. 10, the solar thermal panel 200 may further include the contamination determination unit 230.

The contamination determination unit 230 includes a memory for storage, and reference information for determining contamination may be stored in the memory. The reference information may be a range (reference range) of a refrigerant temperature difference in a normal solar photovoltaic panel. The reference information may be statistical information obtained through repeated experiments. For example, the reference information may be an average value of the refrigerant temperature difference (the second temperature value−the first temperature value) obtained by repeatedly measuring the first temperature value of the first temperature sensor 221 and the second temperature value of the second temperature sensor 222 on the plurality of normal solar photovoltaic panels. This average value may vary according to external environmental factors such as a sun altitude/weather and so on, and may be an average value of a predetermined range obtained through the same/similar process in each external environment.

The contamination determination unit 230 calculates the refrigerant temperature difference (the second temperature value−the first temperature value) from the difference between the first temperature value and the second temperature value received from the communicating unit 223, and compares the calculated refrigerant temperature difference with the reference information to determine whether the solar photovoltaic panel 100 is contaminated.

After the contamination determination unit 230 reads the reference information for determining contamination stored in the memory, the contamination determination unit 230 determines whether the calculated refrigerant temperature difference falls within the reference range. In addition, the contamination determination unit 230 determines that the panel is normal when the calculated refrigerant temperature difference falls within the reference range, and determines that the panel is contaminated when the calculated refrigerant temperature difference is less than the reference range.

When the contamination panel is determined by the contamination determination unit 230, a controller of the hybrid panel generates a control command that drives at least one of the first roller 310 and the second roller 320 that constitute the cleaning unit 300 of the hybrid panel, and transmits the control command to the control circuit of the driving motor that drives the first roller 310 and the second roller 320. When the driving motor is rotated, the transparent seat S is rolled, and at the same time, the contaminated region of the transparent sheet S may be automatically cleaned by the refrigerant that flows through the refrigerant flow path 210 while the transparent sheet S is moved between the solar photovoltaic panel 100 and the solar thermal panel 200.

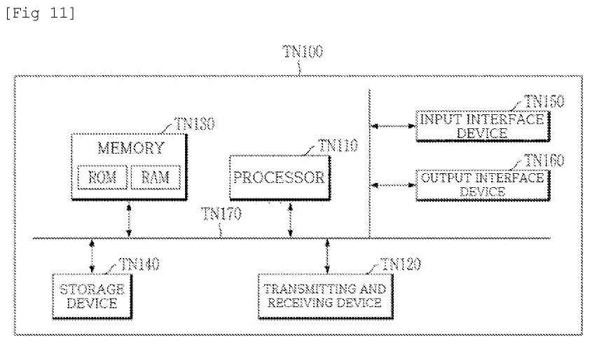

FIG. 11 is a view illustrating a computing device according to an embodiment of the present disclosure. A computing device TN100 in FIG. 11 may be a hardware configuration of the management server 30 or the contamination determination unit 230 described in this specification.

In the embodiment illustrated in FIG. 11, the computing device TN100 may include at least one processor TN110, and may include a transmitting and receiving device TN120, and a memory TN130. In addition, the computing device TN100 may further include a storage device TN140, an input interface device TN150, an output interface device TN160, and so on. The components included in the computing device TN100 may communicate with each other by being connected to each other with a bus TN170.

The processor TN110 may execute a program command stored in at least one of the memory TN130 and the storage device TN140. The processor TN110 may refer to a central processing unit (CPU), a graphics processing unit (GPU), or a dedicated processor in which methods according to an embodiment of the present disclosure are performed. The processor TN110 may be configured to implement procedures, functions, methods, and so on described in relation to an embodiment of the present disclosure. The processor TN110 may control each component of the computing device TN100.

The memory TN130 and the storage device TN140 may respectively store various information related to the operation of the processor TN110. The memory TN130 and the storage device TN140 may respectively be configured as at least one of a volatile storage medium and a non-volatile storage medium. For example, the memory TN130 may include at least one of a read only memory (ROM) and a random access memory (RAM).

The transmitting and receiving device TN120 may transmit or receive a wired signal or a wireless signal. The transmitting and receiving device TN120 is connected to a network and may perform communication.

Meanwhile, the present disclosure may be implemented as a computer program. The present disclosure may be combined with hardware and may be implemented as a computer program stored in a computer readable recording medium.

Methods according to embodiments of the present disclosure may be implemented in a readable program form by various computer means and may be recorded on a computer readable recording medium. Here, the recording medium may include a program command, a data file, a data structure, and so on, alone or in combination.

The program command recorded on the recording medium may be specially designed and configured for the present disclosure, or may be known and used by those skilled in the computer software field.

For example, the recording medium includes a hardware device specially configured to store and execute the program command such as magnetic media such as a hard disk, a floppy disk, and a magnetic tape, optical media such as a CD-ROM and a DVD, magneto-optical media such as a floptical disk, a ROM, a RAM, or a flash memory.

Examples of the program commands include machine code, such as code created by a compiler, and high-level language code executable by a computer using an interpreter.

These hardware devices may be configured to operate as one or more software modules in order to perform the operation of the present disclosure, and the vice versa.

While an embodiment of the present disclosure has been described with reference to the accompanying drawings, it will be apparent to those skilled in the art that various modifications and variations can be made through addition, change, omission, or substitution of components without departing from the spirit and scope of the disclosure as set forth in the appended claims, and these modifications and changes fall within the spirit and scope of the present disclosure as defined in the appended claims.

What is claimed is:

1. A hybrid panel management system comprising:
a solar photovoltaic panel configured to generate electrical energy by receiving sunlight;
a solar thermal panel which is formed on a lower portion of the solar photovoltaic panel and in which a refrigerant flow path where a refrigerant for cooling the solar photovoltaic panel by absorbing heat generated as sunlight irradiates the solar photovoltaic panel flows is formed;
a transparent sheet interposed between the solar photovoltaic panel and the solar thermal panel and formed such that the transparent sheet surrounds an upper surface and a lower surface of the solar photovoltaic panel; and
a cleaning unit configured to roll the transparent sheet with respect to the solar photovoltaic panel so that the transparent sheet is cleaned by the refrigerant that flows along the refrigerant flow path.

2. The hybrid panel management system of claim 1, wherein the cleaning unit comprises a first roller disposed on a first side of the solar photovoltaic panel and a second roller disposed on a second side of the solar photovoltaic panel, and the transparent sheet is cleaned by the refrigerant flowing along the refrigerant flow path formed in the solar thermal panel while the transparent sheet is moved between the solar photovoltaic panel and the solar thermal panel when at least one of the first roller and the second roller rolls the transparent sheet.

3. The hybrid panel management system of claim 1, further comprising:
an unmanned aerial vehicle configured to fly over a region in which a plurality of hybrid panels comprising the solar photovoltaic panel and the solar thermal panel; and
a management server configured to control a flight of the unmanned aerial vehicle and an overall function of the unmanned aerial vehicle and configured to manage the hybrid panels.

4. The hybrid panel management system of claim 3, wherein the management server is configured to receive an image photographed by the unmanned aerial vehicle and configured to determine whether the solar photovoltaic panel is contaminated by using artificial intelligence trained from big data about a contamination state of the solar photovoltaic panel.

5. The hybrid panel management system of claim 1, further comprising a management server configured to manage a plurality of hybrid panels comprising the solar photovoltaic panel and the solar thermal panel,
wherein the solar thermal panel comprises a temperature sensor unit configured to measure and collect a difference in refrigerant temperature between an inlet port and an outlet port of the refrigerant flow path,
the management server comprises a storage unit configured to store a reference range for a contamination determination, and comprises a contamination determination unit configured to determine whether the solar photovoltaic panel is contaminated by comparing the difference in refrigerant temperature and the reference range, and
the reference range is a range of an average value of the difference in refrigerant temperature obtained by repeatedly measuring multiple times of the difference in refrigerant temperature of a plurality of the solar photovoltaic panels that is normal, and is statistical information obtained through repeated experiments.

6. The hybrid panel management system of claim 5, wherein the contamination determination unit determines whether the difference in refrigerant temperature falls within the reference range, determines that the solar photovoltaic panel is normal when the difference in refrigerant temperature falls within the reference range, and determines that the solar photovoltaic panel is contaminated when the difference in refrigerant temperature is less than the reference range.

7. The hybrid panel management system of claim 1, wherein the solar photovoltaic panel comprises a temperature sensor unit configured to measure and collect a difference in refrigerant temperature between an inlet port and an outlet port of the refrigerant flow path, and comprises a contamination determination unit configured to determine, on the basis of the difference in refrigerant temperature that is measured, whether the solar photovoltaic panel is contaminated, and
the contamination determination unit determines whether the difference in refrigerant temperature falls within a reference range for a contamination determination, determines that the solar photovoltaic panel is normal when the difference in refrigerant temperature falls within the reference range, and determines that the solar photovoltaic panel is contaminated when the difference in refrigerant temperature is less than the reference range.
